(19) United States
(12) Patent Application Publication
(10) Pub. No.: US 2015/0185395 A1
(43) Pub. Date: Jul. 2, 2015

(54) EDGE-TYPE BACKLIGHTING MODULE AND LIGHT GUIDE PLATE

(71) Applicant: HON HAI PRECISION INDUSTRY CO., LTD., New Taipei (TW)

(72) Inventor: Shao-Han CHANG, New Taipei (TW)

(21) Appl. No.: 14/510,623

(22) Filed: Oct. 9, 2014

(30) Foreign Application Priority Data
Dec. 26, 2013 (CN) 201310729916.6

(51) Int. Cl. F21V 8/00

(52) U.S. Cl. CPC G02B 6/0031; G02B 6/0021

(57) ABSTRACT

The present disclosure provides an edge-type backlight module including a back cover, a LED light source and a light guide plate. The back cover includes a bottom plate and a plurality of sidewalls. The LED light source with at least one LED is fixed on the bottom plate. The light guide plate is arranged in the back cover, which includes a light incident portion and a reflective portion. The reflective portion is obliquely arranged relative to the bottom plate of the back cover. The light incident portion defines a groove and is configured to receive the LED light source. The reflective potion includes a mirror-like reflective portion and a diffusion reflective portion. The diffusion reflective portion faces at least one LED.

### FIELD

The subject matter herein generally relates to backlight modules, and particularly to an edge-type backlight module and a light guide plate.

### BACKGROUND

A liquid crystal display (LCD) does not have the function of emitting light, therefore a backlight module is needed to be positioned under the LCD panel to provide the LCD panel with a required light source. The typical backlight module can be divided into a direct-light type and an edge-light type according to the location of the light source.

### BRIEF DESCRIPTION OF THE DRAWINGS

Implementations of the present technology will now be described, by way of example only, with reference to the attached figures.

FIG. 1 is an exploded, isometric view of an edge-type backlight module, in accordance with a first embodiment of this disclosure.

FIG. 2 is a partial cross-sectional view of the edge-type backlight module as shown in FIG. 1.

FIG. 3 is an isometric view of a light guide plate of FIG. 1.

FIG. 4 is a partial, enlarged view of circled portion IV of the light guide plate as shown in FIG. 3.

FIG. 5 is a partial, cross-sectional view of a light guide plate, in accordance with a second embodiment of this disclosure.

FIG. 6 is a partial, cross-sectional view of a light guide plate, in accordance with a third embodiment of this disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Unless indicated otherwise, the term “comprising,” when utilized, means “including, but not necessarily limited to”; it specifically indicates open-ended inclusion or membership in the so-described combination, group, series and the like.

The present disclosure is described in relation to an edge-type backlight module.

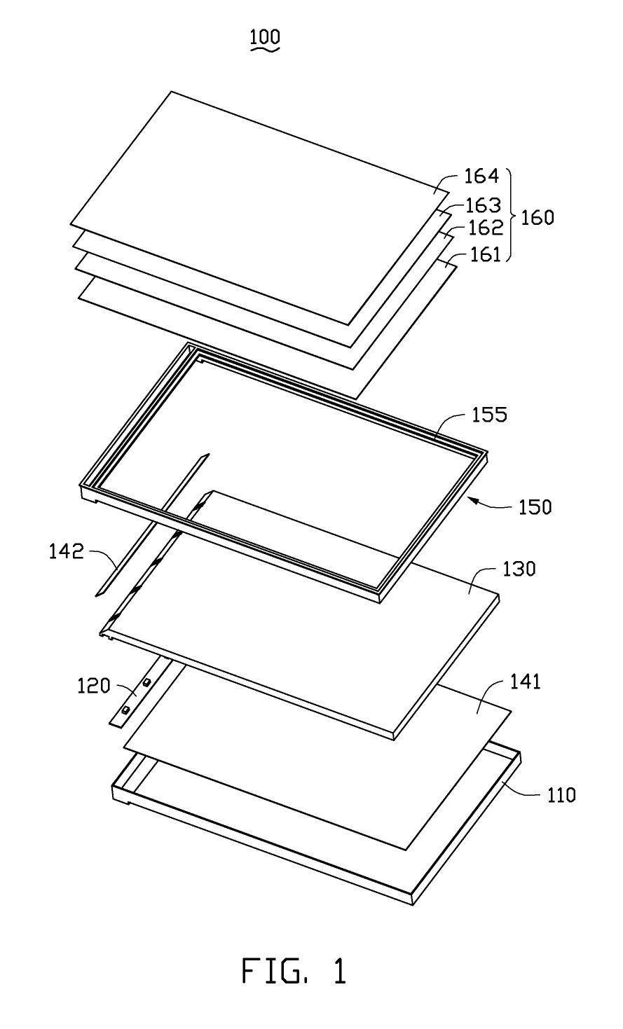

FIG. 1 illustrates a first embodiment of an edge-type backlight module 100 of the disclosure. The edge-type backlight module 100 can include a back cover 110, a Light-Emitting-Diode (LED) light source 120, a light guide plate 130, a reflective sheet 140, a plastic frame 150 mounted on the light guide plate 130, and an optical film 160.

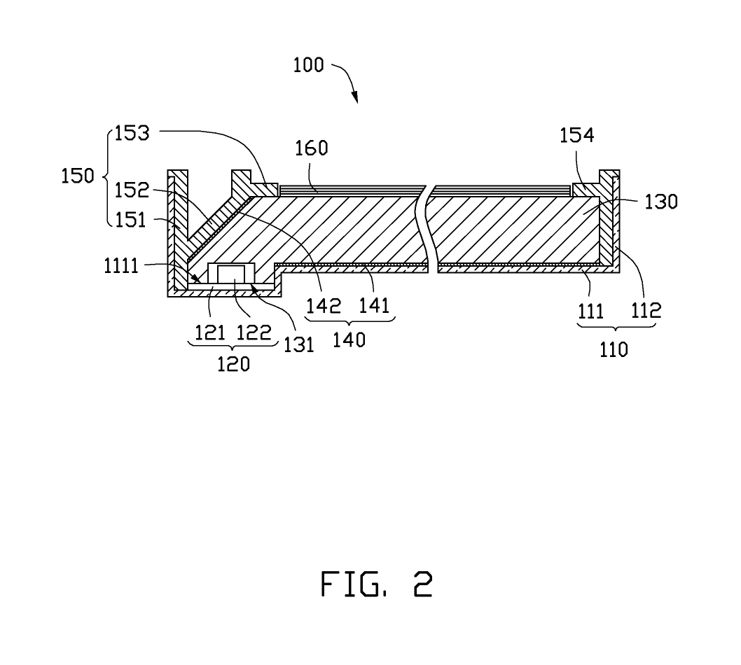

FIG. 2 illustrates that the back cover 110 can include a bottom plate 111 and a plurality of sidewalls 112 extending vertically from one side of the bottom plate 111. The back cover 110 can be made of a metal sheet. The bottom plate 111 can include a recess 1111 adjacent to one of sidewalls 112.

The LED light source 120 can include a striped substrate 121 and a plurality of LEDs 122 arranged on the substrate 121. The LED light source 120 can be received in the recess 1111 of the bottom plate 111.

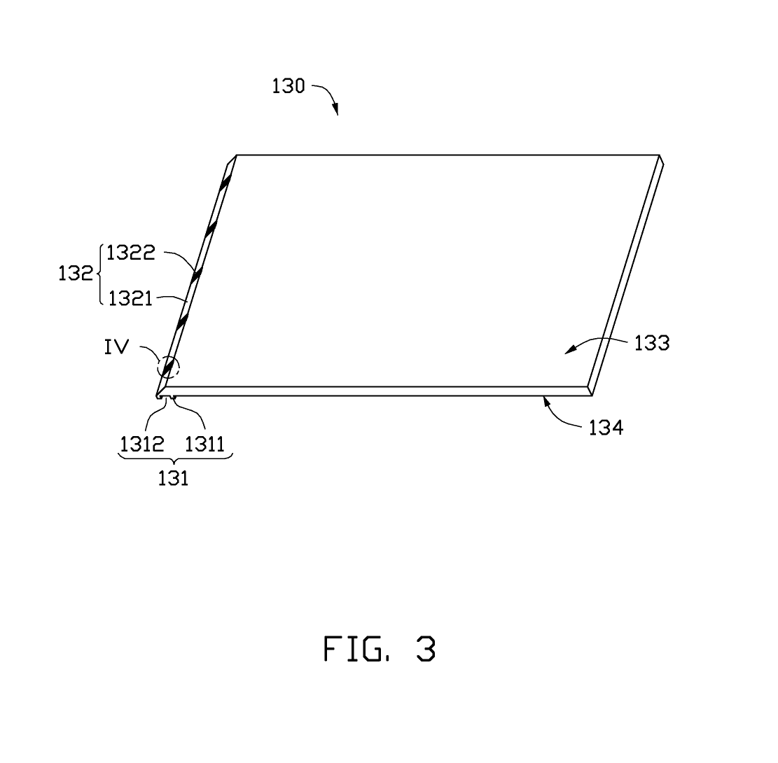

FIG. 3 illustrates that the light guide plate 130 can include a light incident portion 131, a reflective portion 132 opposite to the light incident portion 131, a light-emitting surface 133 and a bottom surface 134 opposite to the light-emitting surface 133. The light incident portion 131 can include two parallel spaced protrusion portions 1311 and a groove 1312 positioned between the two protrusion portions 1311. The two protrusion portions 1311 can be positioned adjacent to an edge of the light guide plate 130 and configured to be received in the recess 1111 (as shown in FIG. 2). The groove 1312 can be rectangular and configured to receive the LED light source 120 (as shown in FIG. 2). The reflective portion 132 can be obliquely arranged adjacent to an edge of the light guide plate 130 and include a mirror-like reflective portion 1321 and a diffusion reflective portion 1322. The diffusion reflective portion 1322 faces at least one LED 122 of the LED light source 120 (see in FIG. 2). The diffusion reflective portion 1322 can make a high luminous intensity light emit from the plurality of LEDs 122 (as shown in FIG. 2) and enter into the light guide plate 130, whereby the light transmitted to the light guide plate 130 can be uniform. The light-emitting surface 133 can be adjacent to the reflective portion 132. The bottom surface 134 parallel to the light-emitting surface 133 can be attached to the bottom plate 111 (as shown in FIG. 2).

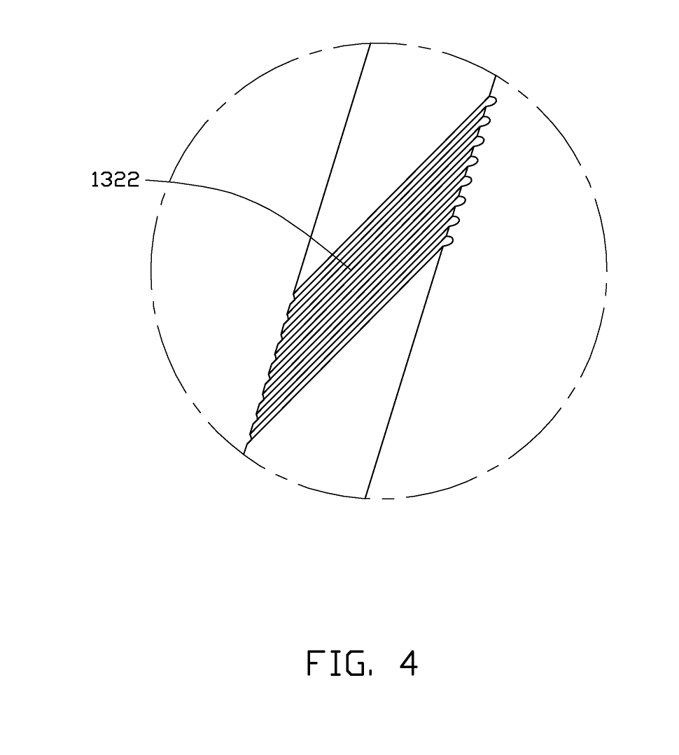

FIG. 4 illustrates that the diffusion reflective portion 1322 can be a column-shaped groove uniformly distributed in an array. In other embodiments, the diffusion reflective portion 1322 can be other shapes, such as a V-shaped groove and textured surface.

FIG. 2 illustrates that the reflective sheet 140 can include a first reflective sheet 141 and a second reflective sheet 142. The first reflective sheet 141 can be attached to the bottom plate 111 and positioned between the light guide plate 130 and the bottom plate 111. The second reflective sheet 142 can be attached to the reflective portion 132 and configured to improve the reflective efficiency of the reflective portion 132 (see in FIG. 3).

The plastic frame 150 can be a rectangular frame, which can include a plurality of side frames 151, a resisting portion 152 obliquely arranged on the one side frame 151, a first limiting portion 153 extending horizontally from the resisting portion 152 and a second limiting portion 154 extending perpendicularly from the remaining side frames 152. The first limiting portion 153 and the second limiting portion 154 cooperatively compose an inner frame 155 (as shown in FIG. 1). The resisting portion 152 can be resisted with the reflective portion 132 (as shown in FIG. 3) of the light guide plate 130. Both the first limiting portion 153 and the second limiting portion 154 can be resisted with the light-emitting surface 133 (as shown in FIG. 3) of the light guide plate 130, and configured for preventing light leakage. The light guide plate 130 can be firmly positioned between the plastic frame 150 and the bottom plate 111 configured for preventing the light guide plate 130 from deforming.

FIG. 1 illustrates that the optical film 160 can include a number of complementary optical elements. In the illustrated embodiment, the optical film 160 can include a first diffusion film 161, a first prism lens 162, a second prism lens 163, and a second diffusion film 164 stacked together in order. The optical film 160 can be mounted on the light-emitting surface 133 and can be received in the inner frame 155 (see in FIG. 3).

In assembly, the LED light source 120 can be received in the recess 1111 of the bottom plate 111. The first reflective sheet 141 can be attached to the first reflective sheet 141. The light guide plate 130 can then be positioned in the back cover 110. The bottom surface 134 can be attached to the reflective sheet 141 and the reflective portion 132 can be attached to the second reflective sheet 142. The light incident portion 131 of the light guide plate 130 can be received in the recess 1111 of the bottom plate 111. The groove 1312 can cover the plurality of LEDs 122. After that the plastic frame 150 can be mounted on the light guide plate 130 and received in the back cover 110, the resisting portion 152 is resisted with the reflective portion 132 of the light guide plate 130. Therefore, the first limiting portion 153 and the second limiting 154 can be resisted with the part of the light-emitting surface 133 of the light guide plate 130. At last, the optical film 160 can be received in the inner frame 155 and can be attached to the light-emitting surface 133 of the light guide plate 130.

In use, a lateral emergent light of the plurality of LEDs 122 can be transmitted into the light incident portion 131 and reflected by the second reflective sheet 142. Then the reflected light can be transmitted into the light guide plate 130. Meanwhile a positive emergent light of the plurality of LEDs 122 with high intensity can be transmitted into the light guide plate 130 by diffusion through the diffusion reflective portion 1322. The diffusion reflected light and other reflected light can be mixed in the light guide 130 and transmitted by the total reflective manner, thereby the light transmitted to the optical films 160 can be substantially uniform. Finally, the luminance uniformity of the edge-type backlight module 100 can be realized.

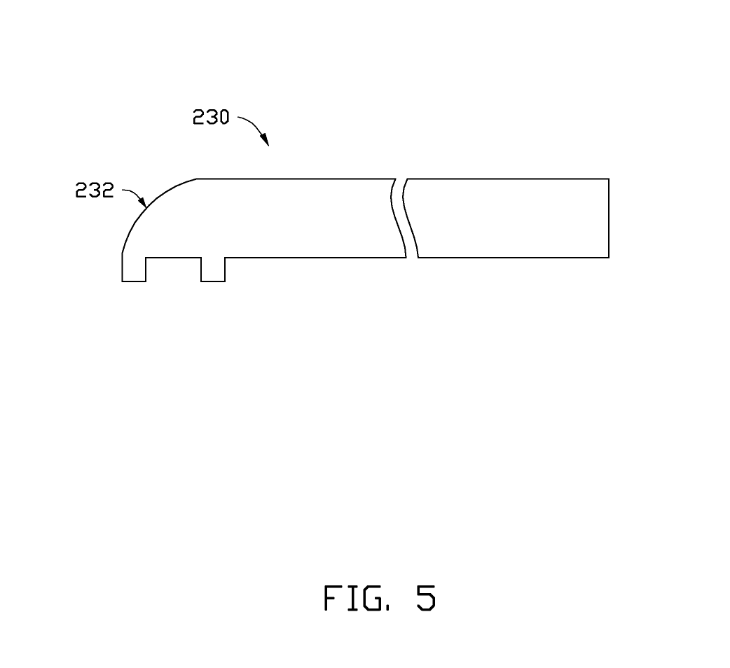

FIG. 5 illustrates a light guide plate 230 in a second embodiment of this disclosure. The light guide plate 230 is the same as the first embodiment, except that a reflective portion 232 of the light guide plate 230 can be a curved surface. The reflective portion 232 has a reflection and spotlight effect preventing the light loss due to repeated reflection.

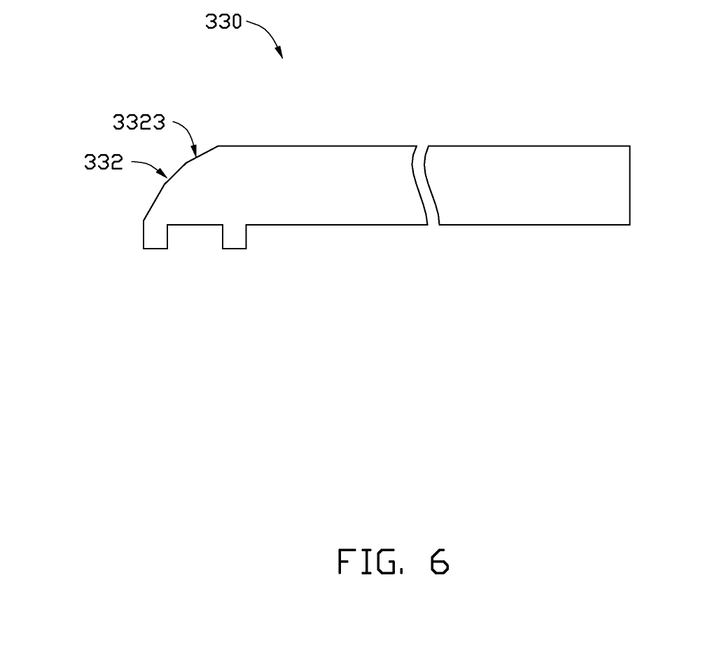

FIG. 6 illustrates a light guide plate 330 in a third embodiment of this disclosure. The light guide plate 330 is the same as the first embodiment, except that a reflective portion 332 of the light guide plate 330 can be composed of a plurality of continuous planes 3323 with different inclinations. The reflective portion 332 can make light with different inclinations transmit into the light guide plate 330 preventing the light loss due to repeated reflection.

In the other embodiments, a coating layer (not shown) can coat the surface of the reflective portion of the light guide plate with high reflectivity for replacing the second reflective sheet to improve the light utilization. The reflectivity factor of the coating layer is above 0.9.

As described above, the reflective portion 132 can be positioned on the light guide plate and the diffusion reflective portion 1322 can be positioned on the reflective portion 132. The lateral emergent light of the plurality of LEDs 122 can be transmitted into the light guide plate 130 by the reflective portion 132. The positive emergent light with high intensity emitted from the plurality of LEDs 122 can be transmitted into the light guide plate 130 by diffusion through the diffusion reflective portion 1322 for improving the uniformity of the entering light and light utilization. The present disclosure can realize both the luminance uniformity and thin design of frame of edge-type backlight module 100. Through the reflective portion 132 directly positioned on the light guide plate 130, the edge-type backlight module 130 can be easily assembled. Through the metal back cover 110 with high thermal conductivity, the heat from the plurality of LEDs 122 can be timely dissipated. Thereby the heat dissipation effect of the edge-type backlight module 100 can be improved.

The embodiments shown and described above are only examples. Many details are often found in the art such as the other features of an edge-type backlight module. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An edge-type backlight module comprising:
an back cover comprises a bottom plate and a plurality of sidewalls vertically extending from sides of the bottom plate;
a LED light source positioned on the bottom plate, wherein the LED light source includes at least one LED; and
a light guide plate positioned in the back cover;
wherein the light guide plate comprises a light incident portion near one sidewall of the back cover and a reflective portion opposite to the light incident portion; the reflective portion is arranged oblique to the bottom plate of the back cover; the light incident portion defines a groove, and configured for receiving the LED light source; the reflective potion includes a mirror-like reflective portion and a diffusion reflective portion; and the diffusion reflective portion faces at least one LED of the LED light source.

2. The edge-type backlight module as claimed in claim 1, wherein the bottom plate includes a recess near one sidewall, and the light incident portion and the LED light source are received in the recess.

3. The edge-type backlight module as claimed in claim 1, wherein the light incident portion further includes two parallel protrusion portions, and the groove is positioned between the two protrusion portions.

4. The edge-type backlight module as claimed in claim 1, wherein the reflective portion is an inclined plane.

5. The edge-type backlight module as claimed in claim 1, wherein the reflective portion is a curved surface.

6. The edge-type backlight module as claimed in claim 1, wherein the reflective portion is composed of a plurality of continuous planes with different inclinations.

7. The edge-type backlight module as claimed in claim 1, wherein the mirror-like reflection portion and the diffusion reflective portion are coated by a coating layer with high reflectivity.

8. The edge-type backlight module as claimed in claim 1, wherein the edge-type backlight module includes a plastic frame positioned on the light guide plate, a reflective sheet, and an optical film; the reflective sheet includes a first reflective sheet attached to the bottom plate and a second reflective sheet attached to the reflective portion; the optical film is positioned on the side of light guide plate opposite to the back cover.

9. A light guide plate comprising:
a light incident portion; and
a reflective portion opposite to the light incident portion;
wherein the reflective portion is obliquely arranged on one side of the light guide plate relative to a bottom plate of the back cover; the light incident portion includes a groove; and the reflective potion includes a mirror-like reflective portion and a diffusion reflective portion.

10. The light guide as claimed in claim 9, wherein the light incident portion further includes two parallel protrusion portions, and the groove is positioned between the two protrusion portions.

11. The light guide as claimed in claim 9, wherein the reflective portion is an inclined plane.

12. The light guide as claimed in claim 9, wherein the reflective portion is a curved surface.

13. The light guide as claimed in claim 9, wherein the reflective portion is composed of a plurality of continuous planes with different inclinations.

14. The light guide as claimed in claim 9, wherein the mirror-like reflection portion and the diffusion reflective portion are coated by a coating layer with high reflectivity.

15. A LED light source device for backlighting an LCD display, the LED light source device comprising:
a light guide plate having an elongate groove recessed thereinto, wherein and the elongate groove is located along a peripheral edge of the light guide plate;
a plurality of LEDs positioned along and adjacent to the elongate groove and oriented to emit light rays into the groove;
an interior of the elongate groove comprising a light incident portion that receives light rays from the plurality of LEDs, wherein the light incident portion is configured to direct received light rays toward a light directing reflective portion on an opposite side of the light incident portion from the plurality of LEDs; and
the reflective portion comprising a series of alternating mirror-like reflective portions and diffusion reflective portions, wherein the reflective portion is obliquely oriented to the light guide plate for reflectively directing light rays from the LEDs into and across the light guide plate and thereby establishing the LED light source device for backlighting an LCD display.
